(19) United States
(12) Patent Application Publication
(10) Pub. No.: US 2022/0184954 A1
(43) Pub. Date: Jun. 16, 2022

(54) Liquid Ejecting Head, Method Of Using Liquid Ejecting Head, And Liquid Ejecting Apparatus

(71) Applicant: Seiko Epson Corporation, Tokyo (JP)

(72) Inventors: Takahiro KATAKURA, Okaya (JP); Toshiro MURAYAMA, Fujimi (JP)

(21) Appl. No.: 17/549,984

(22) Filed: Dec. 14, 2021

(30) Foreign Application Priority Data
Dec. 15, 2020 (JP) 2020-207379

(51) Int. Cl. B41J 2/14; B41J 2/16

(52) U.S. Cl. CPC B41J 2/14233; B41J 2002/14266; B41J 2/161

(57) ABSTRACT

The liquid ejecting head satisfies at least one of conditions that structures of the first nozzle and the second nozzle are different from each other, that structures of the first pressure chamber and the second pressure chamber are different from each other, that structures of the first driving element and the second driving element are different from each other, and that structures of the first individual flow channel and the second individual flow channel are different from each other.

The present application is based on, and claims priority from JP Application Serial Number 2020-207379, filed Dec. 15, 2020, the disclosure of which is hereby incorporated by reference herein in its entirety.

### BACKGROUND

### 1. Technical Field

The present disclosure relates to a liquid ejecting head, a method of using a liquid ejecting head, and a liquid ejecting apparatus.

### 2. Related Art

A liquid ejecting apparatus typified by an ink jet printer generally includes a liquid ejecting head that ejects a liquid such as an ink. For example, a head disclosed in JP-A-2018-099822 (Patent Document 1) includes nozzles that eject a liquid, pressure chambers communicating with the nozzles, piezoelectric elements that apply a pressure to the liquid in the pressure chambers, and flow channels communicating with the pressure chambers.

According to the head disclosed in Patent Document 1, multiple sets each including a nozzle, a pressure chamber, a piezoelectric element, and a flow channel are formed to have the same structure so as to obtain a desired ejection characteristic regarding a specific type of ink. Here, when using an ink having a different characteristic from that of the specific type of ink, it is still possible to maintain the ejection characteristic of the different ink within a desired range by adjusting a waveform of a voltage to be applied to each piezoelectric element on the condition that such a difference is small. However, the head disclosed in Patent Document 1 cannot obtain the desired ejection characteristic when using an ink having a significantly different characteristic from that of the specific type of ink. In this case, a user has to check and prepare another appropriate head. Hence, this head has a lack of usability.

### SUMMARY

An aspect of a liquid ejecting head according to the present disclosure provides a liquid ejecting head which includes a first ejection element that ejects a prescribed liquid, and a second ejection element that ejects the prescribed liquid with a different ejection characteristic from an ejection characteristic of the first ejection element. Here, the first ejection element includes a first nozzle that ejects the liquid, a first pressure chamber that communicates with the first nozzle, a first driving element that applies a pressure to the liquid in the first pressure chamber, and a first individual flow channel that communicates with the first pressure chamber. The second ejection element includes a second nozzle that ejects the liquid, a second pressure chamber that communicates with the second nozzle, a second driving element that applies a pressure to the liquid in the second pressure chamber, and a second individual flow channel that communicates with the second pressure chamber. Moreover, an ejection characteristic of the first ejection element and an ejection characteristic of the second ejection element when using the prescribed liquid are different from each other by satisfying at least one of conditions that structures of the first nozzle and the second nozzle are different from each other, that structures of the first pressure chamber and the second pressure chamber are different from each other, that structures of the first driving element and the second driving element are different from each other, and that structures of the first individual flow channel and the second individual flow channel are different from each other.

An aspect of a method of using a liquid ejecting head according to the present disclosure provides a method of using the liquid ejecting head of the aforementioned aspect, which includes obtaining, as a first step, first information concerning an ejection characteristic when driving the first driving element in a state of filling the first pressure chamber with the prescribed liquid, obtaining, as a second step, second information concerning an ejection characteristic when driving the second driving element in a state of filling the second pressure chamber with the prescribed liquid, and selecting, as a third step, one of ejection elements including the first ejection element and the second ejection element based on the first information and the second information.

An aspect of a liquid ejecting apparatus according to the present disclosure includes the liquid ejecting head according to the aforementioned aspect, and a control unit that controls an operation to eject the liquid from the liquid ejecting head.

### BRIEF DESCRIPTION OF THE DRAWINGS

FIG. 1 is a configuration diagram schematically illustrating a liquid ejecting apparatus according to a first embodiment.

FIG. 2 is an exploded perspective view of a liquid ejecting head according to the first embodiment.

FIG. 3 is a cross-sectional view taken along the III-III line in FIG. 2.

FIG. 4 is a plan view illustrating a first ejection element and a second ejection element in the first embodiment.

FIG. 5 is a block diagram illustrating a configuration example of a system using the liquid ejecting head according to the first embodiment.

FIG. 6 is a graph illustrating an example of a waveform of a drive pulse.

FIG. 7 is a diagram for explaining a measurement by means of actual measurement of an ink ejection characteristic.

FIG. 8 is a flowchart illustrating a method of using the liquid ejecting head according to the first embodiment.

FIG. 9 is a block diagram illustrating a configuration example of a system using a liquid ejecting head according to a second embodiment.

FIG. 10 is a flowchart illustrating a method of using the liquid ejecting head according to the second embodiment.

FIG. 11 is a plan view illustrating a first ejection element, a second ejection element, a third ejection element, and a fourth ejection element in a third embodiment.

FIG. 12 is a block diagram illustrating a configuration example of a liquid ejecting apparatus according to a fourth embodiment.

### DESCRIPTION OF EXEMPLARY EMBODIMENTS

Preferred embodiments according to the present disclosure will be described below with reference to the accompanying drawings. Note that dimensions and scales of constituents in the drawings may be different from reality as appropriate and some constituents may be schematically illustrated in order to facilitate the understanding thereof. In addition, the scope of the present disclosure is not limited only to these embodiments unless there is a statement in the following description to indicate a limitation of the scope of the disclosure in particular.

Here, x axis, y axis, and z axis being orthogonal to one another will be used in the following description as appropriate. Meanwhile, a direction extending along the x axis will be referred to as x1 direction and an opposite direction to the x1 direction will be referred to as x2 direction. Likewise, mutually opposite directions extending along the y axis will be referred to as y1 direction and y2 direction, and mutually opposite directions extending along the z axis will be referred to as z1 direction and z2 direction. In the meantime, a view in the direction along the z axis will be referred to as “plan view”.

Here, the z axis is typically a vertical axis and the z2 direction corresponds to a downward direction in terms of the vertical direction. However, the z axis does not always have to be the vertical axis. In the meantime, the x axis, the y axis, and the z axis are typically orthogonal to one another. However, these axes are not limited only to this configuration. The axes may intersect with one another at angles within a range from 80° to 100° inclusive, for example.

### 1-1. Overall Configuration of Liquid Ejecting Apparatus

### 1. First Embodiment

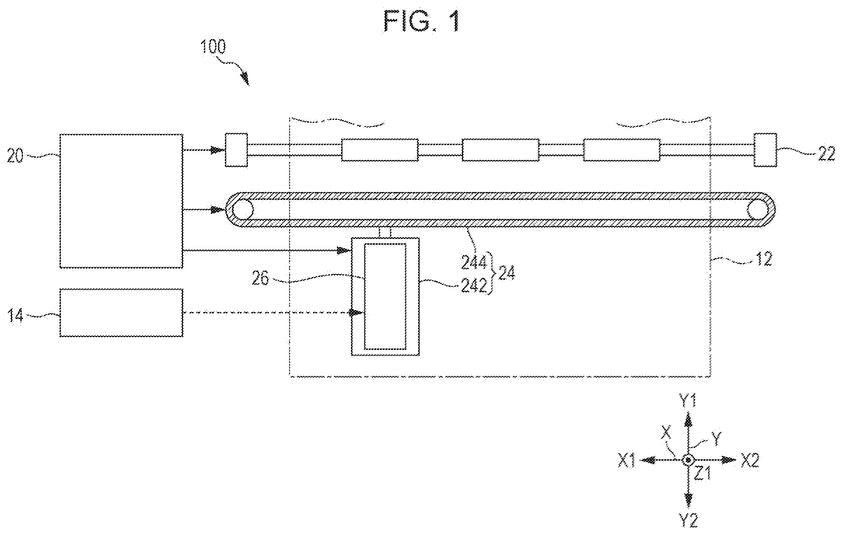

FIG. 1 is a configuration diagram schematically illustrating a liquid ejecting apparatus 100 according to a first embodiment. The liquid ejecting apparatus 100 is an ink jet printing apparatus that transforms an ink being an example of a liquid into droplets and ejects the droplets onto a medium 12. The medium 12 is typically printing paper. Note that the medium 12 is not limited only to the printing paper and may be a printing target made of a desired material such as a resin film and a fabric.

As illustrated in FIG. 1, a liquid container 14 that stores the ink is attached to the liquid ejecting apparatus 100. Specific examples of an aspect of the liquid container 14 include, a cartridge attachable to/removable from the liquid ejecting apparatus 100, an ink package in the form of a bag made of a flexible film, an ink-refillable ink tank, and the like. Any types of inks may be stored in the liquid container 14.

The liquid ejecting apparatus 100 includes a control unit 20, a transportation mechanism 22, a movement mechanism 24, and a liquid ejecting head 26.

The control unit 20 controls operations of respective elements in the liquid ejecting apparatus 100. Here, the control unit 20 is an example of a “control unit” that controls an ejecting operation of the ink from the liquid ejecting head 26. The control unit 20 includes a processing circuit such as a central processing unit (CPU) and a field programmable gate array (FPGA), and a storage circuit such as a semiconductor memory.

The transportation mechanism 22 transports the medium 12 in the y2 direction under the control of the control unit 20. The movement mechanism 24 reciprocates the liquid ejecting head 26 in the x1 direction and the x2 direction under the control of the control unit 20. In the example illustrated in FIG. 1, the movement mechanism 24 includes a substantially box-shaped transportation body 242 which is referred to as a carriage to house the liquid ejecting head 26, and a transportation belt 244 to which the transportation body 242 is fixed. Here, the number of the liquid ejecting heads 26 to be mounted on the transportation body 242 is not limited only to one, and two or more liquid ejecting heads 26 may be mounted thereon. Meanwhile, the transportation body 242 may mount the above-described liquid container 14 in addition to the liquid ejecting head 26.

The liquid ejecting head 26 ejects the ink supplied from the liquid container 14 to the medium 12 in the z2 direction from each of nozzles under the control of the control unit 20. As a consequence of carrying out the ejection in parallel with the transportation of the medium 12 by the transportation mechanism 22 and with the reciprocation of the liquid ejecting head 26 by the movement mechanism 24, an image is formed on a surface of the medium 12 with the ink. The liquid ejecting head 26 includes multiple ejection elements that eject the ink with mutually different ejection characteristics even when the same type of the ink is used therein. Here, examples of such an ejection characteristic include an ejecting speed, an ink quantity, the number of satellites, stability, and the like.

### 1-2. Overall Configuration of Liquid Ejecting Head

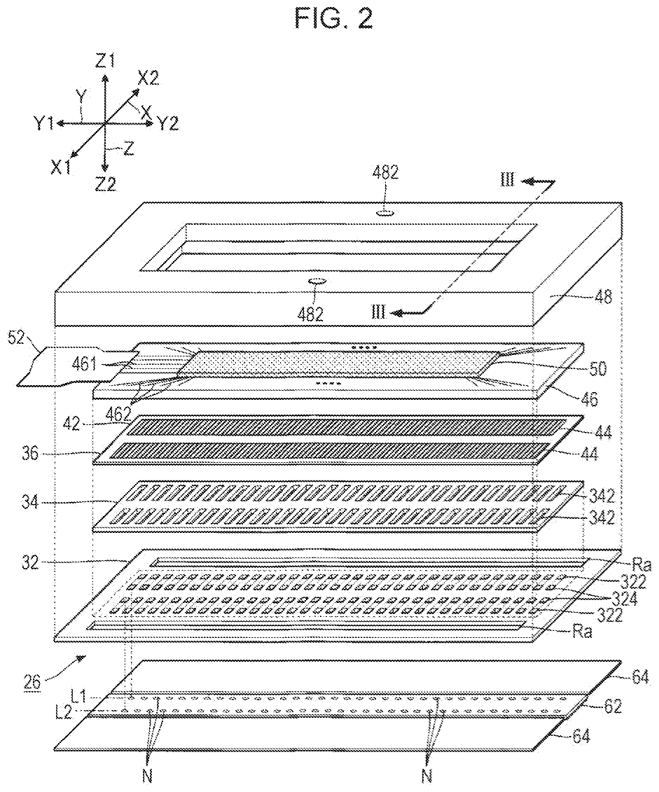

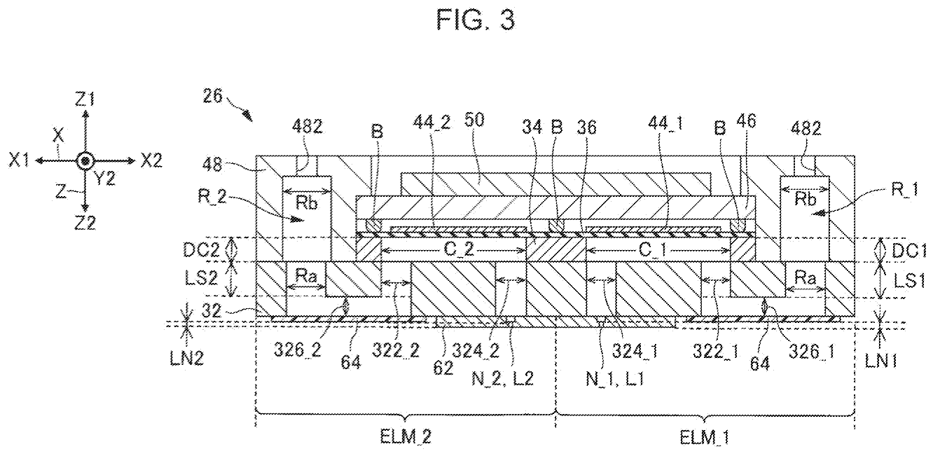

FIG. 2 is an exploded perspective view of the liquid ejecting head 26 according to the first embodiment. FIG. 3 is a cross-sectional view taken along the III-III line in FIG. 2. As illustrated in FIG. 2, the liquid ejecting head 26 includes nozzles N that are arranged in the direction along the y axis. In the example illustrated in FIG. 2, the nozzles N are divided into a first row L1 and a second row L2, which are arranged in the direction along the x axis at an interval in between. Each of the first row L1 and the second row L2 is a set of the nozzles N arranged linearly in the direction along the y axis.

Each nozzle N on the first row L1 is a first nozzle N_1 illustrated in FIG. 3. Each nozzle N on the second row L2 is a second nozzle N_2 illustrated in FIG. 3. Here, the liquid ejecting head 26 is divided into a first ejection element ELM_1 that includes elements related to the first nozzles N_1 and a second ejection element ELM_2 that includes elements related to the second nozzles N_2.

As illustrated in FIG. 3, a branch number “_1” is affixed to each of reference signs of the elements constituting the first ejection element ELM_1. A branch number “_2” is affixed to each of reference signs of the elements constituting the second ejection element ELM_2. However, in the following description, these branch numbers may be omitted as indicated in FIG. 2 when the elements need not be distinguished between the first ejection element ELM_1 and the second ejection element ELM_2.

In the example illustrated in FIG. 3, the first ejection element ELM_1 and the second ejection element ELM_2 generally have mutually symmetric structures in terms of the direction along the x axis. However, the first ejection element ELM_1 and the second ejection element ELM_2 have mutually different configurations such that characteristics of ink ejection from the first nozzles N_1 and the second nozzles N_2 are different from each other when the same type of the ink is used therein.

Here, locations of the first nozzles N_1 and the second nozzles N_2 in the direction along the y axis may coincide with or differ from one another. In the following description, a configuration in which the locations of the first nozzles N_1 and the second nozzles N_2 in the direction along the y axis coincide with one another will be discussed as an example.

As illustrated in FIG. 2, the liquid ejecting head 26 includes a flow channel substrate 32, a pressure chamber substrate 34, a nozzle plate 62, vibration absorbers 64, a vibration plate 36, piezoelectric elements 44, a wiring substrate 46, a housing 48, and a driving circuit 50.

The flow channel substrate 32 and the pressure chamber substrate 34 are stacked in this order in the z1 direction to form flow channels for supplying the ink to the nozzles N. The vibration plate 36, the wiring substrate 46, the housing 48, and the driving circuit 50 are installed in a region located away in the z1 direction from the pressure chamber substrate 34. On the other hand, the nozzle plate 62 and the vibration absorbers 64 are installed in a region located away in the z2 direction from the flow channel substrate 32. The respective elements in the liquid ejecting head 26 are generally plate members that are elongate in the y direction, and are joined to one another by using an adhesive, for example.

The nozzle plate 62 is a plate member provided with the nozzles N serving as the first nozzles N_1 and the second nozzles N_2. Each of the nozzles N is a circular through hole that allows passage of the ink. The nozzle plate 62 is manufactured, for example, by processing a single crystalline silicon substrate with semiconductor manufacturing techniques that apply a processing technique such as dry etching and wet etching. However, other publicly known methods and materials may be used in manufacturing the nozzle plate 62 when appropriate. In the meantime, the cross-sectional shape of each nozzle N is not limited only to the circular shape. The nozzle N may be formed into a non-circular shape such as a polygonal shape and an oval shape.

In the flow channel substrate 32, a space Ra, supply flow channels 322, communication flow channels 324, and a supply liquid chamber 326 are formed for each of the first row L1 and the second row L2. Here, each of the supply flow channels 322 corresponding to the first row L1 is a first individual flow channel 322_1 included in the first ejection element ELM_1. Each of the supply flow channels 322 corresponding to the second row L2 is a second individual flow channel 322_2 included in the second ejection element ELM_2. Each of the communication flow channels 324 corresponding to the first row L1 is a communication flow channel 324_1 included in the first ejection element ELM_1. Each of the communication flow channels 324 corresponding to the second row L2 is a communication flow channel 342_2 included in the second ejection element ELM_2. The supply liquid chamber 326 corresponding to the first row L1 is a first common flow channel 326_1 included in the first ejection element ELM_1. The supply liquid chamber 326 corresponding to the second row L2 is a second common flow channel 326_2 included in the second ejection element ELM_2.

The space Ra is an elongate opening that extends in the direction along the y axis in plan view from the direction along the z axis. Each of the supply flow channels 322 and the communication flow channels 324 is a through hole provided for each nozzle N. The supply liquid chamber 326 is an elongate space that extends in the direction along the y axis across the nozzles N, which establishes communication between the space Ra and the supply flow channels 322. Each of the communication flow channels 324 overlaps one of the nozzles N corresponding to the relevant communication flow channel 324 in plan view.

The pressure chamber substrate 34 is a plate member provided with pressure chambers C referred to as cavities for each of the first row L1 and the second row L2. Here, each of the pressure chambers C corresponding to the first row L1 is a first pressure chamber C_1 included in the first ejection element ELM_1. Each of the pressure chambers C corresponding to the second row L2 is a second pressure chamber C_2 included in the second ejection element ELM_2.

The pressure chambers C are arranged in the direction along the y axis. Each pressure chamber C is an elongate space formed for each nozzle N and extending in the direction along the x axis in plan view. As with the nozzle plate 62 mentioned above, each of the flow channel substrate 32 and the pressure chamber substrate 34 is manufactured, for example, by processing a single crystalline silicon substrate with the semiconductor manufacturing techniques. However, other publicly known methods and materials may be used in manufacturing each of the flow channel substrate 32 and the pressure chamber substrate 34 when appropriate.

Each pressure chamber C is a space located between the flow channel substrate 32 and the vibration plate 36. The pressure chambers C for each of the first row L1 and the second row L2 are arranged in the direction along the y axis. Meanwhile, each pressure chamber C communicates with the communication flow channel 324 and the supply flow channel 322, respectively. As a consequence, the pressure chamber C communicates with the nozzle N through the communication flow channel 324, and communicates with the space Ra through the supply flow channel 322 and the supply liquid chamber 326.

The vibration plate 36 is located on a surface of the pressure chamber substrate 34 oriented in the z2 direction. The vibration plate 36 is an elastically vibratable plate member. The vibration plate 36 includes a first layer and a second layer, for example, and these layers are stacked in this order in the z1 direction. The first layer is an elastic film made of silicon oxide (SiO₂), for example. The elastic film is formed, for instance, by subjecting one of surfaces of the single crystalline silicon substrate to thermal oxidation. The second layer is an insulating film made of zirconium oxide (ZrO₂), for example. The insulating film is formed, for instance, by depositing a zirconium layer by sputtering and then subjecting this layer to thermal oxidation. Note that the vibration plate 36 is not limited only to the above-described structure formed by stacking the first layer and the second layer. The vibration plate 36 may be formed from a single layer or three or more layers, for example.

The piezoelectric elements 44 corresponding one by one to the nozzles N for each of the first row L1 and the second row L2, respectively, are located on a surface of the vibration plate 36 oriented in the z1 direction. Here, each of the piezoelectric elements 44 corresponding to the first row L1 is a first driving element 44_1 included in the first ejection element ELM_1. Each of the piezoelectric elements 44 corresponding to the second row L2 is a second driving element 44_2 included in the second ejection element ELM_2.

Each piezoelectric element 44 is a passive element which is deformed by supply of a drive signal. Each piezoelectric element 44 takes on an elongate shape that extends in the direction along the x axis in plan view. The piezoelectric elements 44 are arranged in the direction along the y axis in conformity to the pressure chambers C. Each piezoelectric element 44 overlaps the corresponding pressure chamber C in plan view.

Although it is not illustrated, each piezoelectric element 44 includes a first electrode, a piezoelectric layer, and a second electrode. These elements are stacked in the z1 direction in this order. One electrode out of the first electrode and the second electrode is an individual electrode located away from other electrodes of the same type provided to the respective piezoelectric elements 44. The drive signal is applied to the one electrode. The other electrode out of the first electrode and the second electrode is a common electrode of a strip shape that extends in the direction of the y axis continuously across the piezoelectric elements 44. A predetermined reference potential is supplied to the other electrode. Examples of metal materials of these electrodes include platinum (Pt), aluminum (Al), nickel (Ni), gold (Au), copper (Cu), and the like. It is possible to use one of these materials alone or two or more types thereof in combination in the form of an alloy, a laminate, or the like. The piezoelectric layer is made of a piezoelectric material such as lead zirconate titanate (Pb(Zr, Ti)O₃). The piezoelectric layer takes on a strip shape that extends in the direction along the y axis continuously across the piezoelectric elements 44, for example. However, through holes that penetrate the piezoelectric layer are formed in the piezoelectric layer in such a way as to extend in the direction along the x axis, each of which is provided in a region corresponding to a gap between every two adjacent pressure chambers C in plan view. When the vibration plate 36 vibrates in conjunction with the deformation of each of the piezoelectric elements 44, a pressure inside the pressure chamber C is changed whereby the ink is ejected from the corresponding nozzle N.

The housing 48 is a case for storing the ink to be supplied to the pressure chambers C. As illustrated in FIG. 3, the housing 48 of this embodiment is provided with spaces Rb corresponding to the first row L1 and the second row L2, respectively. Each space Rb in the housing 48 communicates with the corresponding space Ra in the flow channel substrate 32. A space defined by the space Ra and the space Rb functions as a liquid storage chamber (a reservoir) to store the ink to be supplied to the pressure chambers C. Here, the liquid storage chamber corresponding to the first row L1 is a first liquid storage chamber R_1 included in the first ejection element ELM_1. The liquid storage chamber corresponding to the second row L2 is a second liquid storage chamber R_2 included in the second ejection element ELM_2.

The ink is supplied to the first liquid storage chamber R_1 and the second liquid storage chamber R_2 through pouring ports 482 formed in the housing 48. The ink in the first liquid storage chamber R_1 and the second liquid storage chamber R_2 is supplied to the pressure chambers C through the supply liquid chambers 326 and the respective supply flow channels 322. The vibration absorbers 64 are films are flexible films (compliance substrates) that form wall surface of the first liquid storage chamber R_1 and the second liquid storage chamber R_2. The vibration absorbers 64 absorbs variations in pressure of the ink in the first liquid storage chamber R_1 and the second liquid storage chamber R_2.

Each wiring substrate 46 is a plate member provided with wiring for electrically coupling the driving circuit 50 to the piezoelectric elements 44. A surface of the wiring substrate 46 oriented in the z2 direction is joined to the vibration plate 36 through conductive bumps B. Meanwhile, the driving circuit 50 is mounted on another surface of the wiring substrate 46 oriented in the z1 direction. The driving circuit 50 is an integrated circuit (IC) chip that outputs a reference voltage as well as the drive signals for driving the respective piezoelectric elements 44. Though the wiring substrate 46 is a rigid substrate in the example illustrated in FIGS. 2 and 3, the wiring substrate 46 may be a flexible substrate instead. In this case, the wiring substrate 46 may be integrated with external wiring 52 described below.

End portions of the external wiring 52 are bonded to the surface of the wiring substrate 46 oriented in the z1 direction. The external wiring 52 is formed from coupling components such as flexible printed circuits (FPCs) and a flexible flat cables (FFCs). Here, as illustrated in FIG. 2, the wiring substrate 46 is provided with wires 461 for electrically coupling the external wiring 52 to the driving circuit 50, and wires 462 to which the drive signals and the reference voltage outputted from the driving circuit 50 are supplied.

### 1-3. Details of First Ejection Element and Second Ejection Element

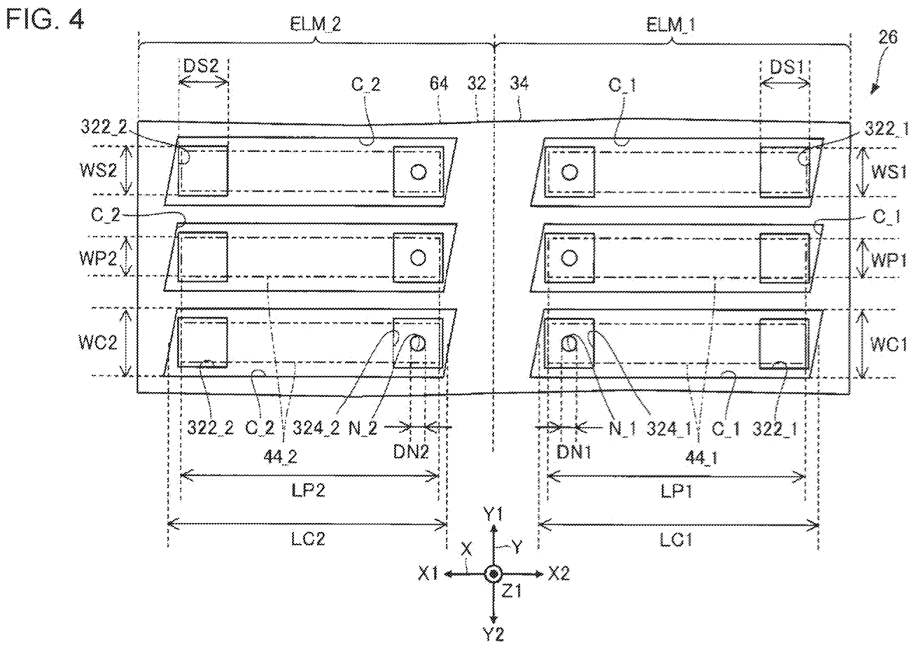

FIG. 4 is a plan view illustrating the first ejection element ELM_1 and the second ejection element ELM_2 in the first embodiment. FIG. 4 illustrates layouts of the nozzles N, the pressure chambers C, the supply flow channels 322, the communication flow channels 324, and the piezoelectric elements 44 in plan view regarding the first ejection element ELM_1 and the second ejection element ELM_2. Note that the shapes, locations, sizes and the like of the respective components of the first ejection element ELM_1 and the second ejection element ELM_2 are not limited to the example illustrated in FIG. 4 and may be set otherwise as appropriate.

As mentioned earlier, the liquid ejecting head 26 includes the first ejection element ELM_1 that ejects a prescribed liquid and the second ejection element ELM_2 that ejects the prescribed liquid with different ejection characteristic from that of the first ejection element ELM_1.

Here, the first ejection element ELM_1 includes the first nozzles N_1 that eject the liquid, the first pressure chambers C_1 that communicate with the first nozzles N_1, the first driving elements 44_1 that apply the pressure to the liquid in the first pressure chambers C_1, and the first individual flow channels 322_1 that communicate with the first pressure chambers C_1. The second ejection element ELM_2 includes the second nozzles N_2 that eject the liquid, the second pressure chambers C_2 that communicate with the second nozzles N_2, the second driving elements 44_2 that apply the pressure to the liquid in the second pressure chambers C_2, and the second individual flow channels 322_2 that communicate with the second pressure chambers C_2.

In the meantime, the ejection characteristics of the first ejection element ELM_1 and the second ejection element ELM_2 when using the prescribed liquid are different from each other as a consequence of satisfying at least one of the following conditions (a), (b), (c), and (d):

(a) Structures of the first nozzle N_1 and the second nozzle N_2 are different from each other;

(b) Structures of the first pressure chamber C_1 and the second pressure chamber C_2 are different from each other;

(c) Structures of the first driving element 44_1 and the second driving element 44_2 are different from each other; and

(d) Structures of the first individual flow channel 322_1 and the second individual flow channel 322_2 are different from each other.

In the above-described liquid ejecting head 26, the ejection characteristics of the first ejection element ELM_1 and the second ejection element ELM_2 when using the same liquid are different from each other. Accordingly, it is possible to broaden the range of selecting the type of the liquid for obtaining a desired ejection characteristic with one liquid ejecting head 26 as compared to the configuration in which the ejection element included in the liquid ejecting head is just one type. For this reason, even when using the liquid which cannot bring about a desired ejection characteristic with one of the first ejection element ELM_1 and the second ejection element ELM_2, it is possible to obtain the desired ejection characteristic by using the other ejection element. As a consequence, it is not necessary to prepare a liquid ejecting head for each type of the liquid or to reduce the degree of such a necessity. In this way, it is possible to provide the liquid ejecting head 26 which is excellent in usability.

The condition (a) mentioned above is realized by making dimensions, shapes, and the like of the first nozzle N_1 and the second nozzle N_2 different from each other, for example. When making the structures of the first nozzle N_1 and the second nozzle N_2 different from each other from this point of view, a length LN2 of the second nozzle N_2 along a direction of circulation of the liquid therein may be different from a length LN1 of the first nozzle N_1 along a direction of circulation of the liquid therein. For example, it is possible to set a larger amount of ejection with each droplet as the length along the direction of circulation of the liquid in the nozzle N being either the first nozzle N_1 or the second nozzle N_2 is smaller, and the ejection characteristic tends to be easily improved in this case even when a viscosity of the liquid is high. Accordingly, a desired ejection characteristic can be obtained by selecting and using one of the first ejection element ELM_1 and the second ejection element ELM_2 in which the lengths of the nozzles N along the direction of circulation of the liquid therein are different from each other.

Meanwhile, when making the structures of the first nozzle N_1 and the second nozzle N_2 different from each other, a cross-sectional area of the second nozzle N_2 along a direction intersecting with the direction of circulation of the liquid therein may be different from a cross-sectional area of the first nozzle N_1 along a direction intersecting with the direction of circulation of the liquid therein. For example, it is possible to set a larger amount of ejection with each droplet as the cross-sectional area of the nozzle N along the direction of circulation of the liquid therein is larger, and the ejection characteristic tends to be easily improved in this case even when the viscosity of the liquid is high. Accordingly, a desired ejection characteristic can be obtained by selecting and using one of the first ejection element ELM_1 and the second ejection element ELM_2 in which the cross-sectional areas of the nozzles N along the direction intersecting with the direction of circulation of the liquid therein are different from each other.

Here, the cross-sectional area of the first nozzle N_1 along the direction intersecting with the direction of circulation of the liquid therein is set by adjusting a minimum width, that is, a diameter DN1 of the first nozzle N_1 along the direction intersecting with the direction of circulation of the liquid therein. Likewise, the cross-sectional area of the second nozzle N_2 along the direction intersecting with the direction of circulation of the liquid therein is set by adjusting a minimum width, that is, a diameter DN2 of the second nozzle N_2 along the direction intersecting with the direction of circulation of the liquid therein.

The condition (b) mentioned above is realized by making dimensions, shapes, materials, and the like of the first pressure chamber C_1 and the second pressure chamber C_2 different from each other, for example. When making the structures of the first pressure chamber C_1 and the second pressure chamber C_2 different from each other from this point of view, a length LC_2 of the second pressure chamber C_2 along a direction of circulation of the liquid therein may be different from a length LC_1 of the first pressure chamber C_1 along a direction of circulation of the liquid therein. For example, a change in volume of the pressure chamber C being either the first pressure chamber C_1 or the second pressure chamber C_2 attributed to the drive of the piezoelectric element 44 therein becomes larger as the length of the pressure chamber C along the direction of circulation of the liquid therein is larger. Hence, it is possible to set a larger amount of ejection with each droplet. Accordingly, a desired ejection characteristic can be obtained by selecting and using one of the first ejection element ELM_1 and the second ejection element ELM_2 in which the lengths of the pressure chambers C along the direction of circulation of the liquid therein are different from each other.

Meanwhile, when making the structures of the first pressure chamber C_1 and the second pressure chamber C_2 different from each other, a cross-sectional area of the second pressure chamber C_2 along a direction intersecting with the direction of circulation of the liquid therein may be different from a cross-sectional area of the first pressure chamber C_1 along a direction intersecting with the direction of circulation of the liquid therein. For example, as the cross-sectional area of the pressure chamber C along the direction intersecting with the direction of circulation of the liquid therein becomes larger, a loss attributed to flow channel resistance in the pressure chamber C is reduced more, and compliance of the piezoelectric element 44 therein as well as compliance of the liquid grows larger at the same time. Accordingly, ejection stability of the liquid tends to be increased even when the viscosity of the liquid is low. On the other hand, as the cross-sectional area of the pressure chamber C along the direction intersecting with the direction of circulation of the liquid therein becomes smaller, the pressure inside the pressure chamber C tends to be increased more easily. Accordingly, the desired ejection characteristic can be obtained by selecting and using one of the first ejection element ELM_1 and the second ejection element ELM_2 in which the cross-sectional areas of the pressure chambers C along the direction intersecting with the direction of circulation of the liquid therein are different from each other, depending on the viscosity of the liquid.

Here, the cross-sectional area of the first pressure chamber C_1 along the direction intersecting with the direction of circulation of the liquid therein is set by adjusting a width WC1 or a depth DC1 of the first pressure chamber C_1 along the direction intersecting with the direction of circulation of the liquid therein. Likewise, the cross-sectional area of the second pressure chamber C_2 along the direction intersecting with the direction of circulation of the liquid therein is set by adjusting a width WC2 or a depth DC2 of the second pressure chamber C_2 along the direction intersecting with the direction of circulation of the liquid therein.

The condition (c) mentioned above is realized by making dimensions, shapes, materials, and the like of the first driving element 44_1 and the second driving element 44_2 different from each other, for example. When making the structures of the first driving element 44_1 and the second driving element 44_2 different from each other from this point of view, an area of the second driving element 44_2 may be different from an area of the first driving element 44_1. For example, a change in volume of the pressure chamber C attributed to the drive of piezoelectric element 44 being either the first driving element 44_1 or the second driving element 44_2 becomes larger as the area of the piezoelectric element 44 is larger. Hence, it is possible to set a larger amount of ejection with each droplet. Accordingly, a desired ejection characteristic can be obtained by selecting and using one of the first ejection element ELM_1 and the second ejection element ELM_2 in which the areas of the piezoelectric elements 44 therein are different from each other.

Here, the area of the first driving element 44_1 is an area of a region where the first electrode, the piezoelectric layer, and the second electrode layer of the first driving element 44_1 overlap one another in plan view. Likewise, the area of the second driving element 44_2 is an area of a region where the first electrode, the piezoelectric layer, and the second electrode layer of the second driving element 44_2 overlap one another in plan view.

The condition (d) mentioned above is realized by making dimensions, shapes, and the like of the first individual flow channel 322_1 and the second individual flow channel 322_2 different from each other, for example. When making the structures of the first individual flow channel 322_1 and the second individual flow channel 322_2 different from each other from this point of view, a length LS2 of the second individual flow channel 322_2 along a direction of circulation of the liquid therein may be different from a length LS1 of the first individual flow channel 322_1 along a direction of circulation of the liquid therein. For example, it is possible to set a larger amount of ejection with each droplet as the length along the direction of circulation of the liquid in the supply flow channel 322 being either the first individual flow channel 322_1 or the second individual flow channel 322_2 is larger, and the ejection characteristic tends to be easily improved in this case even when the viscosity of the liquid is high. Accordingly, a desired ejection characteristic can be obtained by selecting and using one of the first ejection element ELM_1 and the second ejection element ELM_2 in which the lengths of the supply flow channels 322 along the direction of circulation of the liquid therein are different from each other.

Meanwhile, when making the structures of the first individual flow channel 322_1 and the second individual flow channel 322_2 different from each other, a cross-sectional area of the second individual flow channel 322_2 along a direction intersecting with the direction of circulation of the liquid therein may be different from a cross-sectional area of the first individual flow channel 322_1 along a direction intersecting with the direction of circulation of the liquid therein. For example, it is possible to set a larger amount of ejection with each droplet as the cross-sectional area of the supply flow channel 322 along the direction of circulation of the liquid therein is smaller, and the ejection characteristic tends to be easily improved in this case even when the viscosity of the liquid is high. Accordingly, a desired ejection characteristic can be obtained by selecting and using one of the first ejection element ELM_1 and the second ejection element ELM_2 in which the cross-sectional areas of the supply flow channels 322 along the direction intersecting with the direction of circulation of the liquid therein are different from each other.

Here, the cross-sectional area of the first individual flow channel 322_1 along the direction intersecting with the direction of circulation of the liquid therein is set by adjusting a width WS1 or a length DS1 of the first individual flow channel 322_1 along the direction intersecting with the direction of circulation of the liquid therein. Likewise, the cross-sectional area of the second individual flow channel 322_2 along the direction intersecting with the direction of circulation of the liquid therein is set by adjusting a width WS2 or a length DS2 of the second individual flow channel 322_2 along the direction intersecting with the direction of circulation of the liquid therein.

In this embodiment, the first ejection element ELM_1 includes the nozzles N arranged as the first nozzles N_1 as mentioned above. Meanwhile, the second ejection element ELM_2 includes the nozzles N arranged as the second nozzles N_2 along the direction of arrangement of the nozzles N of the first ejection element ELM_1. The liquid ejecting head 26 including the first ejection element ELM_1 and the second ejection element ELM_2 is realized by arranging the nozzles N as described above.

Here, the liquid ejecting head 26 includes the first common flow channel 326_1 and the second common flow channel 326_2 as mentioned above. The first common flow channel 326_1 communicates with the first individual flow channels 322_1. The second common flow channel 326_2 does not communicate with the first common flow channel 326_1 but communicates with the second individual flow channels 322_2. By using the first common flow channel 326_1 and the second common flow channel 326_2 as described above, it is possible to supply the liquid to the first nozzles N_1 and the second nozzles N_2 through the individual flow channels in the liquid ejecting head 26 provided with the nozzles N arranged as described above. Accordingly, there is an advantage that it is easier to make the ejection characteristics of the first ejection element ELM_1 and the second ejection element ELM_2 different from each other.

### 1-4. System Using Liquid Ejecting Head

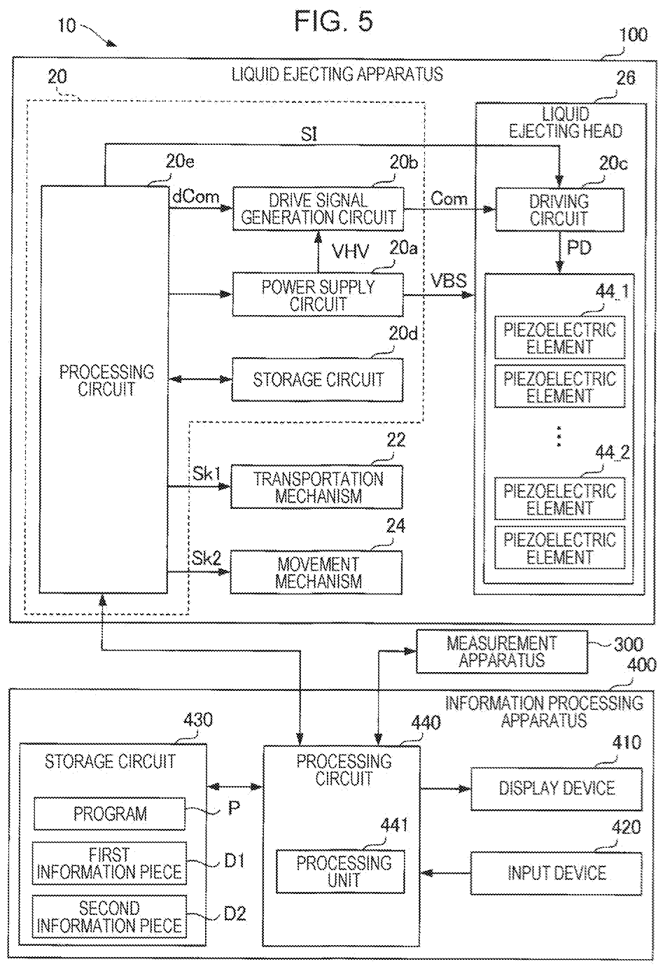

FIG. 5 is a block diagram illustrating a configuration example of a system 10 using the liquid ejecting head 26 according to the first embodiment. The system 10 selects an ejection element out of the first ejection element ELM_1 and the second ejection element ELM_2 by appropriately using a result of measurement obtained by means of at least any one of a simulation and an actual measurement of ink ejection characteristics when driving the first ejection element ELM_1 and the second ejection element ELM_2 by use of a drive pulse PD. The system 10 of this embodiment performs printing by using the selected ejection element.

As illustrated in FIG. 5, the system 10 includes the liquid ejecting apparatus 100, a measurement apparatus 300, and an information processing apparatus 400. These apparatuses will be described one by one below with reference to FIG. 5.

### 1-4a. Liquid Ejecting Apparatus 100

As described above, the liquid ejecting apparatus 100 includes the control unit 20, the transportation mechanism 22, the movement mechanism 24, and the liquid ejecting head 26. Here, as illustrated in FIG. 5, the control unit 20 includes a power supply circuit 20a, a drive signal generation circuit 20b, a storage circuit 20d, and a processing circuit 20e.

The power supply circuit 20a receives power supply from a not-illustrated commercial power source, and generates various prescribed potentials. The various potentials thus generated are supplied to the respective constituents of the liquid ejecting apparatus 100 as appropriate. For example, the power supply circuit 20a generates a power supply potential VHV and an offset potential VBS. The offset potential VBS is supplied to the liquid ejecting head 26 and the like. Meanwhile, the power supply potential VHV is supplied to the drive signal generation circuit 20b and the like.

The drive signal generation circuit 20b is a circuit that generates a drive signal Com for driving the respective piezoelectric elements 44 included in the liquid ejecting head 26. To be more precise, the drive signal generation circuit 20b includes a DA conversion circuit and an amplification circuit, for example. In the drive signal generation circuit 20b, the DA conversion circuit converts an after-mentioned waveform designation signal dCom outputted by the processing circuit 20e from a digital signal into an analog signal, and the amplification circuit amplifies the analog signal by using the power supply potential VHV from the power supply circuit 20a, thus generating the drive signal Com. Here, among waveforms included in the drive signal Com, a signal having a waveform to be actually supplied to the piezoelectric element 44 serves as the drive pulse PD. Details of the drive pulse PD will be described later.

The storage circuit 20d stores various programs to be executed by the processing circuit 20e, and various data such as sprint data to be processed by the processing circuit 20e. For example, the storage circuit 20d includes one or both of the following semiconductor memories, namely, a volatile memory such as a random access memory (RAM), and a non-volatile memory such as a read only memory (ROM), an electrically erasable programmable read-only memory (EEPROM), and a programmable ROM (PROM). The print data is supplied from the information processing apparatus 400, for instance. Here, the storage circuit 20d may be configured as a portion of the processing circuit 20e.

The processing circuit 20e has a function to control operations of the respective constituents of the liquid ejecting apparatus 100 and a function to process the various data. For example, the processing circuit 20e includes at least one processor such as a central processing unit (CPU). Here, the processing circuit 20e may include a programmable logic device such as a field-programmable gate array (FPGA) instead of or in addition to the CPU.

The processing circuit 20e controls the operations of the respective constituents of the liquid ejecting apparatus 100 by executing the programs stored in the storage circuit 20d. Here, the processing circuit 20e generates signals including control signals Sk1, Sk2, and SI as well as the waveform designation signal dCom as signals for controlling the operations of the respective constituents of the liquid ejecting apparatus 100.

The control signal Sk1 is a signal for controlling the drive of the transportation mechanism 22. The control signal Sk2 is a signal for controlling the drive of the movement mechanism 24. The control signal SI is a signal for controlling the drive of the driving circuit 50. To be more precise, the control signal SI designates once in every predetermined unit period as to wither or not the driving circuit 50 is supposed to supply the drive signal Com from the drive signal generation circuit 20b to the liquid ejecting head 26 as the drive pulse PD. By this designation, an amount of the ink to be ejected from the liquid ejecting head 26 and other conditions are designated. The waveform designation signal dCom is a digital signal for designating the waveform of the drive signal Com to be generated by the drive signal generation circuit 20b.

Here, the driving circuit 50 switches whether or not it is appropriate to supply at least part of the waveforms included in the drive signal Com as the drive pulse PD for each of the piezoelectric elements 44 based on the control signal SI.

### 1-4b. Measurement Apparatus 300

The measurement apparatus 300 is an apparatus for measuring the ink ejection characteristics from the liquid ejecting head 26 when actually using the drive pulse PD.

The measurement apparatus 300 of this embodiment is an imaging apparatus that takes an image of a flying state of the ink ejected from the liquid ejecting head 26. To be more precise, the measurement apparatus 300 includes an imaging optical system and an imaging element, for example. The imaging optical system is an optical system that includes at least one imaging lens. The imaging optical system may include various optical elements such as a prism, and may include a zoom lens, a focusing lens, and the like. The imaging element is a charge coupled device (CCD) image sensor or a complementary MOS (CMOS) image sensor, for example. The measurement of the ejection characteristic by using an image taken by the measurement apparatus 300 will be described later in detail.

While the measurement apparatus 300 takes the image of the flying ink in this embodiment, it is also possible to measure the ejection characteristic such as the amount of ejection of the ink from the liquid ejecting head 26 based on a result of taking an image of the ink impacting the print medium and the like. Incidentally, the measurement apparatus 300 only needs to be capable of obtaining the result of measurement corresponding to the ink ejection characteristic from the liquid ejecting head 26. In this regard, the measurement apparatus 300 is not limited only to the imaging apparatus. For example, the measurement apparatus 300 may be another apparatus such as an electronic balance that measures a mass of the ink ejected from the liquid ejecting head 26. Furthermore, as for an information source for measuring the ink ejection characteristic from the liquid ejecting head 26, a result of detection of a waveform of residual vibration that occurs in the liquid ejecting head 26 may be used in addition to the information from the measurement apparatus 300. The residual vibration is vibration that remains in a certain ink flow channel in the liquid ejecting head 26 after driving the piezoelectric element 44, which is detected as a voltage signal from the piezoelectric element 44, for example.

### 1-4c. Information Processing Apparatus 400

The information processing apparatus 400 is a computer that controls operations of the liquid ejecting apparatus 100 and the measurement apparatus 300. Here, the information processing apparatus 400 is communicably connected to the liquid ejecting apparatus 100 and the measurement apparatus 300, respectively, either by wire or wirelessly. This connection may be established by the intermediary of a communication network including the Internet.

As illustrated in FIG. 5, the information processing apparatus 400 includes a display device 410, an input device 420, a storage circuit 430, a processing circuit 440, and a communication circuit 450. These constituents are communicably connected to one another.

The display device 410 displays various images under the control of the processing circuit 440. Here, the display device 410 includes various display panels such as a liquid crystal display panel and an organic electro-luminescence (EL) display panel. Note that the display device 410 may be provided outside of the information processing apparatus 400. Alternatively, the display device 410 may be a constituent of the liquid ejecting apparatus 100.

The input device 420 is a device for accepting operations by a user. For example, the input device 420 includes a pointing device such as a touch pad, a touch panel, and a mouse. In this case, the input device 420 may also serve as the display device 410 when the input device 420 includes the touch panel. Note that the input device 420 may be provided outside of the information processing apparatus 400. Alternatively, the input device 420 may be a constituent of the liquid ejecting apparatus 100.

The communication circuit 450 is an interface which is communicably connected to another system 10. For example, the communication circuit 450 is an interface such as a wired or wireless local area network (LAN), Universal Serial Bus (USB), and High Definition Multimedia Interface (HDMI). Each of the USB and the HDMI is a registered trademark. Here, the communication circuit 450 may be connected to another system 10 through another network such as the Internet. Alternatively, the communication circuit 450 may be regarded as a portion of a processing unit 441 to be described later or may be integrated with the processing circuit 440.

The storage circuit 430 is a device for storing various programs to be executed by the processing circuit 440 and various data to be processed by the processing circuit 440. The storage circuit 430 includes a hard disk drive or a semiconductor memory, for example. Here, part or all of the storage circuit 430 may be provided in a storage device, a server, or the like outside of the information processing apparatus 400.

A program P, a first information piece D1, and a second information piece D2 are stored in the storage circuit 430 of this embodiment. Here, part or all of the program P, the first information piece D1, and the second information piece D2 may be stored in the storage device, the server, or the like outside of the information processing apparatus 400.

The program P causes the processing circuit 440 to execute processing for selecting one of the first ejection element ELM_1 and the second ejection element ELM_2. The first information piece D1 is information concerning the ejection characteristic when driving the first driving element 44_1 while filling the first pressure chamber C_1 with a prescribed liquid. The second information piece D2 is information concerning the ejection characteristic when driving the second driving element 44_2 while filling the second pressure chamber C_2 with the prescribed liquid. These information pieces are generated by the processing unit 441 to be described later.

The processing circuit 440 is a device that has a function to control the respective constituents in the information processing apparatus 400, the liquid ejecting apparatus 100, and the measurement apparatus 300, and a function to process the various data. The processing circuit 440 includes a processor such as a central processing unit (CPU). Here, the processing circuit 440 may be formed from a single processor or formed from two or more processors. Alternatively, part or all of the functions of the processing circuit 440 may be realized by using hardware such as a digital signal processor (DSP), an application specific integrated circuit (ASIC), a programmable logic device (PLD), and a field programmable gate array (FPGA).

The processing circuit 440 reads the program P out of the storage circuit 430 and executes the program P, thus functioning as the processing unit 441.

The processing unit 441 executes processing to obtain the first information piece Dl and the second information piece D2, and processing to select one of the first ejection element ELM_1 and the second ejection element ELM_2 based on the first information piece D1 and the second information piece D2. In addition to the processing mentioned above, the processing unit 441 of this embodiment executes processing to perform printing by using the selected ejection element.

Here, in obtaining the first information piece Dl and the second information piece D2, the result of measurement by means of the simulation or the actual measurement of the ink ejection characteristics from the liquid ejecting head 26 when driving the first ejection element ELM_1 and the second ejection element ELM_2 by use of the drive pulse PD is used as appropriate. Meanwhile, in the simulation or the actual measurement, the waveform of the drive pulse PD is automatically adjusted as needed.

The simulation is realized by a program module that carries out computation for generating the ejection characteristic out of the waveform of the drive pulse PD, for example. Theoretical values or coefficients that are set by use of experiments and the like are applied to formulae of this computation. By using this computation, when parameters, to be described later, representing the waveform of the drive pulse PD is input as an input value, numerical value representing the ejection characteristic such as an ink ejecting speed and an ink quantity is generated as an output value. The actual measurement will be described later in detail in the chapter “1-4e. Actual measurement of ink ejection characteristic” below.

### 1-4d. Example of Waveform of Drive Pulse PD

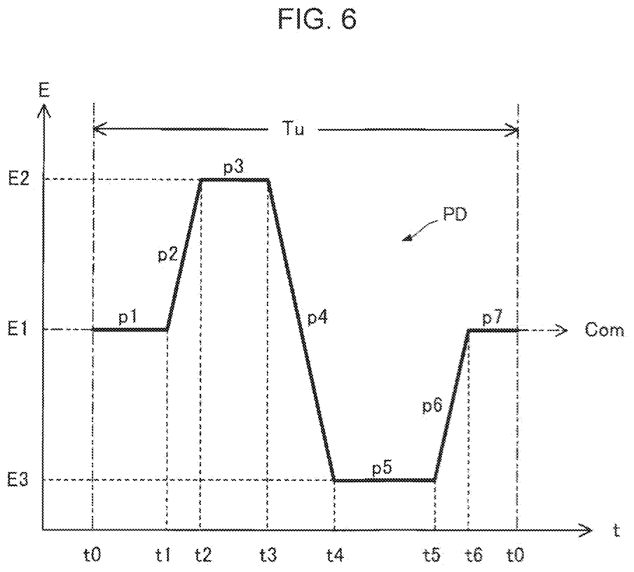

FIG. 6 is a graph illustrating an example of the waveform of the drive pulse PD. FIG. 6 illustrates a change in potential of the drive pulse PD with time, that is, a voltage waveform of the drive pulse PD. Note that the waveform of the drive pulse PD may be any waveform without limitation to the example illustrated in FIG. 6.

As illustrated in FIG. 6, the drive pulse PD is included in the drive signal Com in each unit period Tu. In the example illustrated in FIG. 6, a potential E of the drive pulse PD rises from a potential E1 serving as a reference to a potential E2, then drops to a potential E3 below the potential E1, and then returns to the potential E1.

To be more precise, the potential E of the drive pulse PD is firstly maintained at the potential E1 during a period from a timing t0 to a timing t1, and then rises to the potential E2 during a period from the timing t1 to a timing t2. Thereafter, the potential E of the drive pulse PD is maintained at the potential E2 during a period from the timing t2 to a timing t3, and then drops to the potential E3 during a period from the timing t3 to a timing t4. Subsequently, the potential E is maintained at the potential E3 during a period from the timing t4 to a timing t5, and then rises to the potential E1 during a period from the timing t5 to a timing t6.

The drive pulse PD having the waveform as described above increases the volume of the pressure chamber C of the liquid ejecting head 26 in the period from the timing t1 to the timing t2, and rapidly reduces the volume of the pressure chamber C of the liquid ejecting head 26 in the period from the timing t3 to the timing t4. As a consequence of the change in volume of the pressure chamber C mentioned above, a portion of the ink in the pressure chamber C is ejected as a droplet from the nozzle N.

The above-described waveform of the drive pulse PD can be expressed by a function using parameters p1, p2, p3, p4, p5, p6, and p7 corresponding to the respective periods mentioned above. When the waveform of the drive pulse PD is expressed by this function, it is possible to adjust the waveform of the drive pulse PD by changing the respective parameters. By adjusting the waveform of the drive pulse PD, it is possible to adjust the ink ejection characteristic from the liquid ejecting head 26.

### 1-4e. Actual Measurement of Ink Ejection Characteristic

The above-described information processing apparatus 400 drives the liquid ejecting head 26 by actually using the drive pulse PD, and measures the ink ejection characteristic from the liquid ejecting head 26 based on imaging information from the measurement apparatus 300.

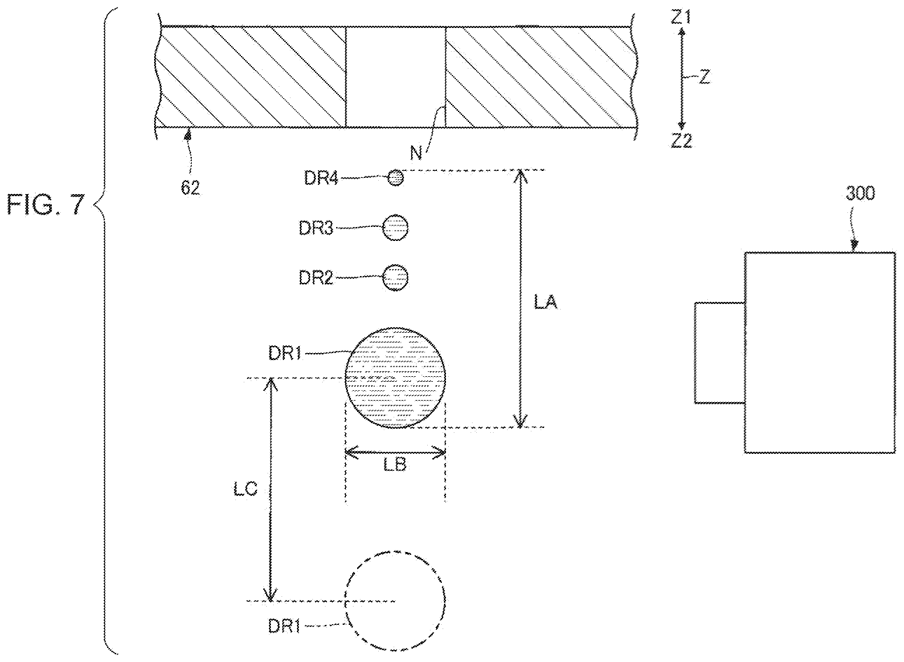

FIG. 7 is a diagram for explaining the measurement by means of the actual measurement of the ink ejection characteristic. As illustrated in FIG. 7, the measurement apparatus 300 of this embodiment takes images of states of flight of ink droplets DR1, DR2, DR3, and DR4 ejected from the nozzle N of the liquid ejecting head 26 from a direction orthogonal to or intersecting with a direction of ejection.

The droplet DR1 is a main droplet. In contrast, each of the droplets DR2, DR3, and DR4 is a droplet called a satellite having a smaller diameter than that of the droplet DR1, which is generated subsequently to the droplet DR1 along with the generation of the droplet DR1. Here, the presence, the number, the sizes, and the like of the droplets DR2, DR3, and DR4 vary depending on the type of the ink, the waveform of the drive pulse PD, or the like.

The amount of ejection of the ink from the liquid ejecting head 26 is calculated based on a diameter LB of the droplet DR1 by using the image taken by the measurement apparatus 300, for example. Meanwhile, the ejection speed of the ink from the liquid ejecting head 26 is calculated based on a moving distance LC of the droplet DR1 after a lapse of a predetermined period and on the predetermined period by continuously taking the images of the droplet DR1, for example. In FIG. 4, the droplet DR1 after the lapse of the predetermined period is indicated with a chain double-dashed line. In the meantime, it is also possible to calculate an aspect ratio (LA/LB) of the ink from the liquid ejecting head 26 as the ink ejection characteristic.

### 1-4f. Method of Using Liquid Ejecting Head 26

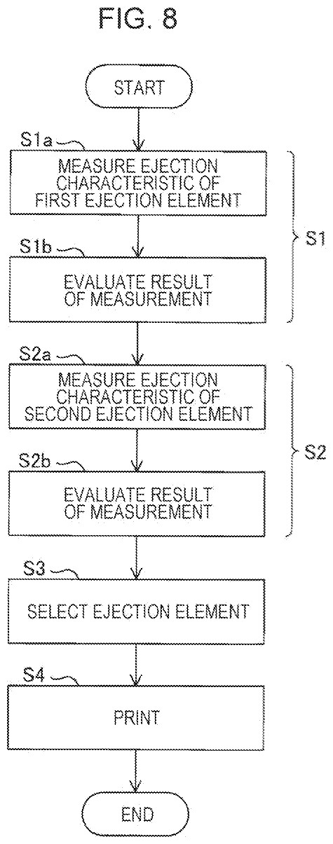

FIG. 8 is a flowchart illustrating a method of using the liquid ejecting head 26 according to the first embodiment. This method of use is carried out by employing the above-described system 10. As illustrated in FIG. 8, this method of use includes step S1 representing an example of a “first step”, step S2 representing an example of a “second step”, step S3 representing an example of a “third step”, and step S4 representing an example of a “fourth step”. The respective steps will be described below one by one.

In step S1, the processing unit 441 obtains the first information piece D1 concerning the ejection characteristic when driving the first driving element 44_1 in the state of filling the first pressure chamber C_1 with the prescribed liquid. In the example illustrated in FIG. 8, step S1 includes step S1a and step S1b.

In step S1a, the processing unit 441 measures the ejection characteristic of the first ejection element ELM_1. This measurement is carried out by ejecting the prescribed liquid by driving the first ejection element ELM_1 while using the drive pulse PD, and actually measuring the ejection characteristic in this instance with the measurement apparatus 300. Here, the processing unit 441 adjusts the waveform of the drive pulse PD by using an evaluation function as needed so as to bring the result of measurement close to a targeted ejection characteristic, for instance. An optimization algorithm such as the Bayesian optimization or the Nelder-Mead method for minimizing an evaluated value of the evaluation function based on the measured ejection characteristic is used for this adjustment. Meanwhile, after the adjustment, the processing unit 441 drives the first ejection element ELM_1 again by using the drive pulse PD that underwent the waveform adjustment, and actually measures the ejection characteristic in this instance with the measurement apparatus 300.

In step S1b, the processing unit 441 evaluates the result of measurement in step Sla. To be more precise, in step S1b, the processing unit 441 generates the first information piece D1 as an outcome of evaluation of the result of measurement in step S1a. Here, the processing unit 441 obtains information concerning an evaluation of the ejection characteristic of the first ejection element ELM_1 as the first information piece D1 based on a physical property of the prescribed liquid and on a predetermined lookup table. The lookup table is information that associates the result of measurement with an evaluated value, for example. Alternatively, the processing unit 441 obtains the information concerning the evaluation of the ejection characteristic of the first ejection element ELM_1 as the first information piece D1 by using a simulation, for example. The obtained first information piece D1 is stored in the storage circuit 430. The simulation is realized by a program for calculating the evaluated value based on the result of evaluation.

Note that the first information piece D1 only needs to be the information concerning the result of measurement in step Sla, which is not limited to the information obtained by using the lookup table or the simulation as mentioned above. For example, this information may be a measurement value in step Sla and the like.

In step S2, the processing unit 441 obtains the second information piece D2 concerning the ejection characteristic when driving the second driving element 44_2 in the state of filling the second pressure chamber C_2 with the prescribed liquid. In the example illustrated in FIG. 8, step S2 includes step S2a and step S2b. Note that a timing to execute the step S2 only needs to be before step S3. In this regard, the step S2 may be executed simultaneously with step S1 or before step S1, for example.

In step S2a, the processing unit 441 measures the ejection characteristic of the second ejection element ELM_2. This measurement is carried out by ejecting the same prescribed liquid as that used in step Sla described above by driving the second ejection element ELM_2 while using the drive pulse PD, and actually measuring the ejection characteristic in this instance with the measurement apparatus 300. Here, as with step S1a described above, the processing unit 441 adjusts the waveform of the drive pulse PD by using the evaluation function as needed so as to bring the result of measurement close to a targeted ejection characteristic, for instance. Meanwhile, after the adjustment, the processing unit 441 drives the second ejection element ELM_2 again by using the drive pulse PD that underwent the waveform adjustment, and actually measures the ejection characteristic in this instance with the measurement apparatus 300.

In step S2b, the processing unit 441 evaluates the result of measurement in step S2a. To be more precise, in step S2b, the processing unit 441 generates the second information piece D2 as an outcome of evaluation of the result of measurement in step S2a. Here, the processing unit 441 obtains information concerning an evaluation of the ejection characteristic of the second ejection element ELM_2 as the second information piece D2 based on the physical property of the prescribed liquid and on the predetermined lookup table. Alternatively, the processing unit 441 obtains the information concerning the evaluation of the ejection characteristic of the second ejection element ELM_2 as the second information piece D2 by using a simulation. The obtained second information piece D2 is stored in the storage circuit 430.

Note that the second information piece D2 only needs to be the information concerning the result of measurement in step S2a, which is not limited to the information obtained by using the lookup table or the simulation as mentioned above. For example, this information may be a measurement value in step S2a and the like.

In step S3, the processing unit 441 selects one of the ejection elements including the first ejection element ELM_1 and the second ejection element ELM_2 based on the first information piece D1 and the second information piece D2. Specifically, in step S3, when the first information piece D1 and the second information piece D2 are generated by using the lookup table or the simulation as described above, for example, the processing unit 441 selects one of the first ejection element ELM_1 and the second ejection element ELM_2 that has a desirable evaluated value by comparing the evaluated values in these information pieces. Here, when each of the first information piece D1 and the second information piece D2 represents the measurement value of the ejection characteristic, for instance, the processing unit 441 compares these measurement values with a target value and selects one of the first ejection element ELM_1 and the second ejection element ELM_2 that is closer to the target value.

In step S4, the processing unit 441 performs the printing by use of the liquid ejected from the liquid ejecting head 26 without employing the ejection element not selected in step S3 but instead by employing the ejection element selected in step S3. Here, the processing unit 441 sets up the driving circuit 50 so as not to employ the ejection element not selected in step S3, for example.

As discussed earlier, the above-described method of using the liquid ejecting head 26 includes step S1 representing the example of the “first step”, step S2 representing the example of the “second step”, and step S3 representing the example of the “third step”. The first information piece D1 concerning the ejection characteristic when driving the first driving element 44_1 in the state of filling the first pressure chamber C_1 with the prescribed liquid is obtained in step Sl. The second information piece D2 concerning the ejection characteristic when driving the second driving element 44_2 in the state of filling the second pressure chamber C_2 with the prescribed liquid is obtained in step S2. Meanwhile, one of the ejection elements including the first ejection element ELM_1 and the second ejection element ELM_2 is selected based on the first information piece D1 and the second information piece D2 in step S3.

According to the above-described method of using the liquid ejecting head 26, it is possible to select the ejection element out of the first ejection element ELM_1 and the second ejection element ELM_2, which is suitable for the type of the liquid.

The method of using the liquid ejecting head 26 of this embodiment includes step S4 representing the example of the “fourth step” in addition to the above-described step S1, step S2, and step S3. The printing is performed in step S4 by use of the liquid ejected from the liquid ejecting head 26 without employing the ejection element not selected in step S3 but instead by employing the ejection element selected in step S3. As a consequence, it is possible to perform the printing by using the ejection element that is suitable for the type of the liquid.

As mentioned earlier, the information concerning the state of the liquid ejected from the first nozzle N_1 by driving the first driving element 44_1 is obtained as the first information piece D1 in step S1. Meanwhile, the information concerning the state of the liquid ejected from the second nozzle N_2 by driving the second driving element 44_2 is obtained as the second information piece D2 in step S2. By using the first information piece D1 and the second information piece D2 in step S3, it is possible to properly select the ejection element corresponding to the type of the liquid.

On the other hand, information concerning the residual vibration that occurs in the first pressure chamber C_1 by driving the first driving element 44_1 may be obtained as the first information piece D1 in step S1. Likewise, information concerning the residual vibration that occurs in the second pressure chamber C_2 by driving the second driving element 44_2 may be obtained as the second information piece D2 in step S2. By obtaining the first information piece D1 and the second information piece D2 by using the results of residual vibration in conjunction with the actual measurements of the states of ejection of the liquid, it is possible to select the ejection element corresponding to the type of the liquid more properly in step S3. Moreover, the first information piece D1 and the second information piece D2 can be obtained without ejecting the liquid. In this case, the configuration of the apparatus to be used can be simplified as compared to the case of actually measuring the states of ejection of the liquid.

Furthermore, as described above, the information concerning the evaluation of the ejection characteristic of the first ejection element ELM_1 may be obtained as the first information piece D1 in step S1 based on the physical property of the prescribed liquid and on the predetermined lookup table. Likewise, the information concerning the evaluation of the ejection characteristic of the second ejection element ELM_2 may be obtained as the second information piece D2 in step S2 based on the physical property of the prescribed liquid and on the predetermined lookup table. By obtaining the first information piece D1 and the second information piece D2 by use of the lookup table in conjunction with the actual measurement of the states of ejection of the liquid, it is possible to select the ejection element corresponding to the type of the liquid more properly. Moreover, the first information piece D1 and the second information piece D2 can be obtained without ejecting the liquid. In this case, the configuration of the apparatus to be used can be simplified as compared to the case of actually measuring the states of ejection of the liquid.

In addition, as described above, the information concerning the evaluation of the ejection characteristic of the first ejection element ELM_1 may be obtained as the first information piece D1 in step S1 by using the simulation. Likewise, the information concerning the evaluation of the ejection characteristic of the second ejection element ELM_2 may be obtained as the second information piece D2 in step S2 by using the simulation. By obtaining the first information piece D1 and the second information piece D2 by using the simulations in conjunction with the actual measurements of the states of ejection of the liquid, it is possible to select the ejection element corresponding to the type of the liquid more properly. Moreover, the first information piece D1 and the second information piece D2 can be obtained without ejecting the liquid. In this case, the configuration of the apparatus to be used can be simplified as compared to the case of actually measuring the states of ejection of the liquid.

### 2. Embodiment

A description will be given below of a second embodiment of the present disclosure. In the embodiment described below, the constituents having the same operations or functions as those in the first embodiment will be denoted by the reference signs used in the description of the first embodiment and detailed explanations thereof will be omitted as appropriate.

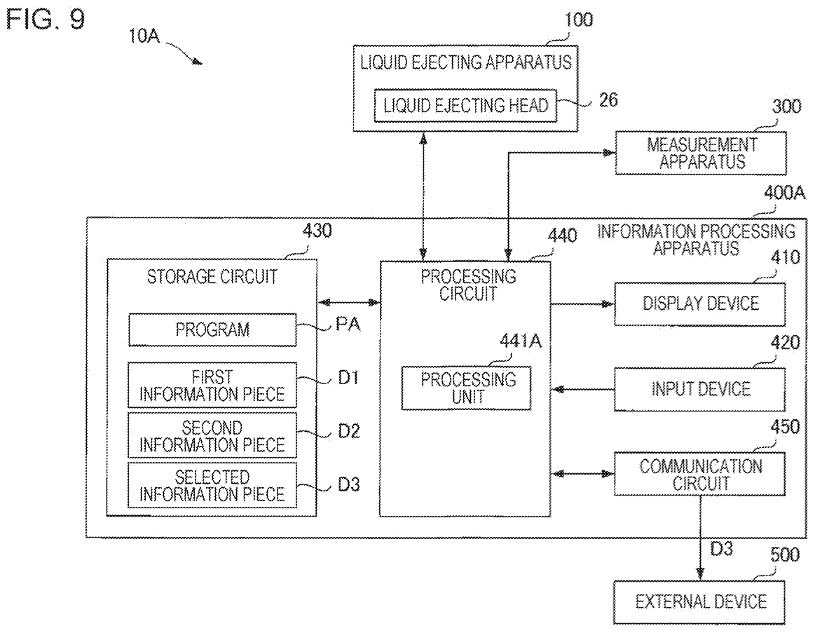

FIG. 9 is a block diagram illustrating a configuration example of a system 10A using the liquid ejecting head 26 according to the second embodiment. The system 10A is the same as the system 10 of the above-described first embodiment except that an information processing apparatus 400A is used therein instead of the information processing apparatus 400. The information processing apparatus 400A is the same as the information processing apparatus 400 except that a program PA is used therein instead of the program P and that the communication circuit 450 is added thereto.

The communication circuit 450 is an interface which is communicably connected to an external device 500 such as a computer and a printer. For example, the communication circuit 450 is an interface such as the wired or wireless local area network (LAN), the Universal Serial Bus (USB), and the High Definition Multimedia Interface (HDMI). Each of the USB and the HDMI is a registered trademark. Here, the communication circuit 450 may be connected to the external device 500 through another network such as the Internet. Alternatively, the communication circuit 450 may be regarded as a portion of a processing unit 441A to be described later or may be integrated with the processing circuit 440.

In this embodiment, the processing circuit 440 reads the program PA out of the storage circuit 430 and executes the program PA, thus functioning as the processing unit 441A.

The processing unit 441A is the same as the processing unit 441 of the above-described first embodiment except that processing to transmit a selected information piece D3 serving as information concerning the selected ejection element to the external device 500 is executed instead of the processing to perform the printing by using the selected ejection element. The selected information piece D3 only needs to be such information that represents the selected ejection element, which is information indicating the row of nozzles of the selected ejection element, for example.

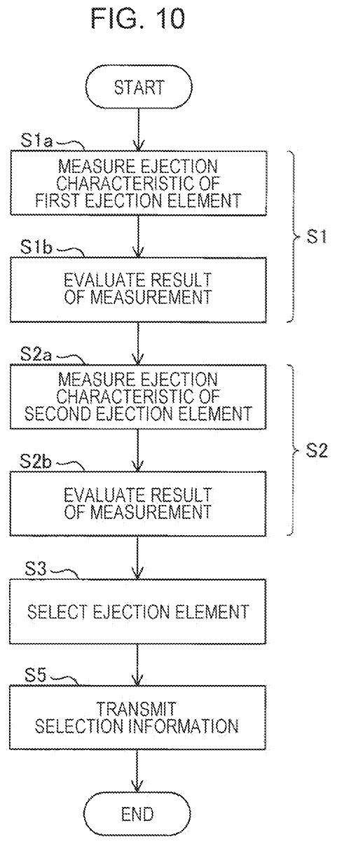

FIG. 10 is a flowchart illustrating the method of using the liquid ejecting head 26 according to the second embodiment. This method of use is carried out by using the above-described system 10A. As illustrated in FIG. 10, the method of use is the same as the method of use according to the above-described first embodiment except that step S5 representing an example of a “fifth step” is included instead of step S4.

In step S5, the processing unit 441A executes the processing to transmit the selected information piece D3 to the external device 500 as information concerning a result of step S3. In this processing, a communication device 45 transmits the selected information piece D3 to the external device 500.

In conclusion, the method of using the liquid ejecting head 26 of this embodiment includes step S5 representing the example of the “fifth step” as mentioned above. The selected information piece D3 is transmitted to the external device 500 in step S5 as the information concerning the result of step S3. Accordingly, it is possible to provide a user with the information concerning the ejection element suitable for the type of the liquid.

### 3. Third Embodiment

A description will be given below of a third embodiment of the present disclosure. In the embodiment described below, the constituents having the same operations or functions as those in the first embodiment will be denoted by the reference signs used in the description of the first embodiment and detailed explanations thereof will be omitted as appropriate.

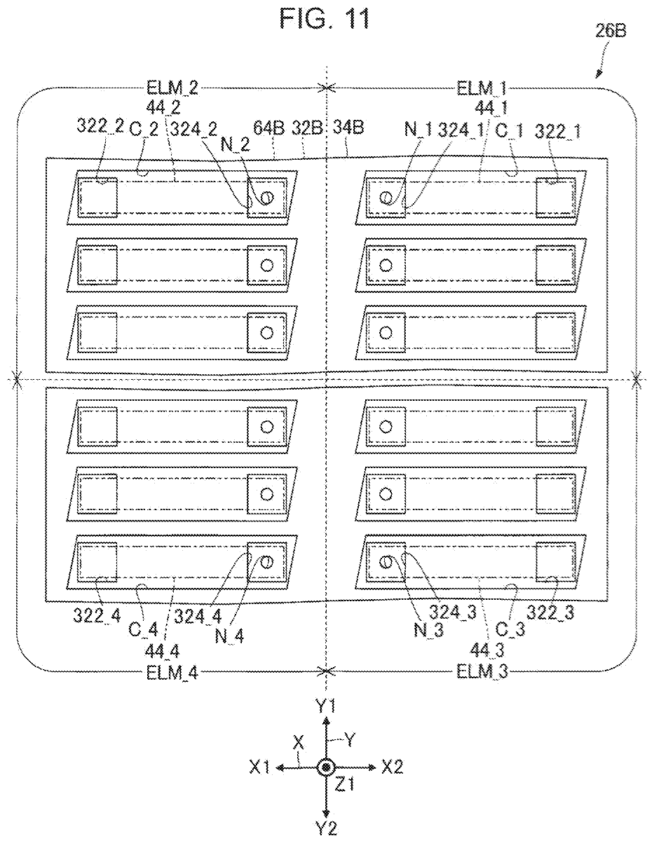

FIG. 11 is a plan illustrating the first ejection element ELM_1, the second ejection element ELM_2, a third ejection element ELM_3, and a fourth ejection element ELM_4 in the third embodiment. As illustrated in FIG. 11, a liquid ejecting head 26B of this embodiment includes the first ejection element ELM_1, the second ejection element ELM_2, the third ejection element ELM_3, and the fourth ejection element ELM_4 having different ejection characteristics from one another when using the liquid of the same type.

In the example illustrated in FIG. 11, the third ejection element ELM_3 is located at a position away in the y2 direction from the first ejection element ELM_1. This third ejection element ELM_3 is realized by making part of the configuration of the first ejection element ELM_1 according to the first embodiment different from the configuration of the remaining portion thereof. Likewise, the fourth ejection element ELM_4 is disposed at a position away in the y2 direction from the second ejection element ELM_2. This fourth ejection element ELM_4 is realized by making part of the configuration of the second ejection element ELM_2 according to the first embodiment different from the configuration of the remaining portion thereof. Note that one of the third ejection element ELM_3 and the fourth ejection element ELM_4 may be omitted.

As described above, the liquid ejecting head 26B of this embodiment includes the third ejection element ELM_3 in addition to the first ejection element ELM_1 and the second ejection element ELM_2. The third ejection element ELM_3 ejects the prescribed liquid with the ejection characteristic that is different from the respective ejection characteristics of the first ejection element ELM_1 and the second ejection element ELM_2.

Here, the third ejection element ELM_3 includes third nozzles N_3 that eject the liquid, third pressure chambers C_3 that communicate with the third nozzles N_3, third driving elements 44_3 that apply a pressure to the liquid in the third pressure chambers C_3, and third individual flow channels 322_3 that communicate with the third pressure chambers C_3.

In the meantime, the ejection characteristics of the first ejection element ELM_1, the second ejection element ELM_2, and the third ejection element ELM_3 when using the prescribed liquid are different from one another as a consequence of satisfying at least one of the following conditions (e), (f), (g), and (h):

(e) A structure of the third nozzle N_3 is different from the structure of the first nozzle N_1 or of the second nozzle N_2;

(f) A structure of the third pressure chamber C_3 is different from the structure of the first pressure chamber C_1 or of the second pressure chamber C_2;

(g) A structure of the third driving element 44_3 is different from the structure of the first driving element 44_1 or of the second driving element 44_2; and (h) A structure of the third individual flow channel 322_3 is different from the structure of the first individual flow channel 322_1 or of the second individual flow channel 322_2.

In the above-described liquid ejecting head 26B, even when using the liquid with which the desired ejection characteristic is not available from two ejection elements out of the first ejection element ELM_1, the second ejection element ELM_2, and the third ejection element ELM_3, it is still possible to obtain the desired ejection characteristic by using the remaining ejection element. Likewise, the ejection characteristic of the fourth ejection element ELM_4 is made different from those of the first ejection element ELM_1, the second ejection element ELM_2, and the third ejection element ELM_3. Here, the fourth ejection element ELM_4 includes fourth nozzles N_4 that eject the liquid, fourth pressure chambers C_4 that communicate with the fourth nozzles N_4, fourth driving elements 44_4 that apply a pressure to the liquid in the fourth pressure chambers C_4, and fourth individual flow channels 322 4 that communicate with the fourth pressure chambers C_4.

### 4. Fourth Embodiment

A description will be given below of a fourth embodiment of the present disclosure. In the embodiment described below, the constituents having the same operations or functions as those in the first embodiment will be denoted by the reference signs used in the description of the first embodiment and detailed explanations thereof will be omitted as appropriate.

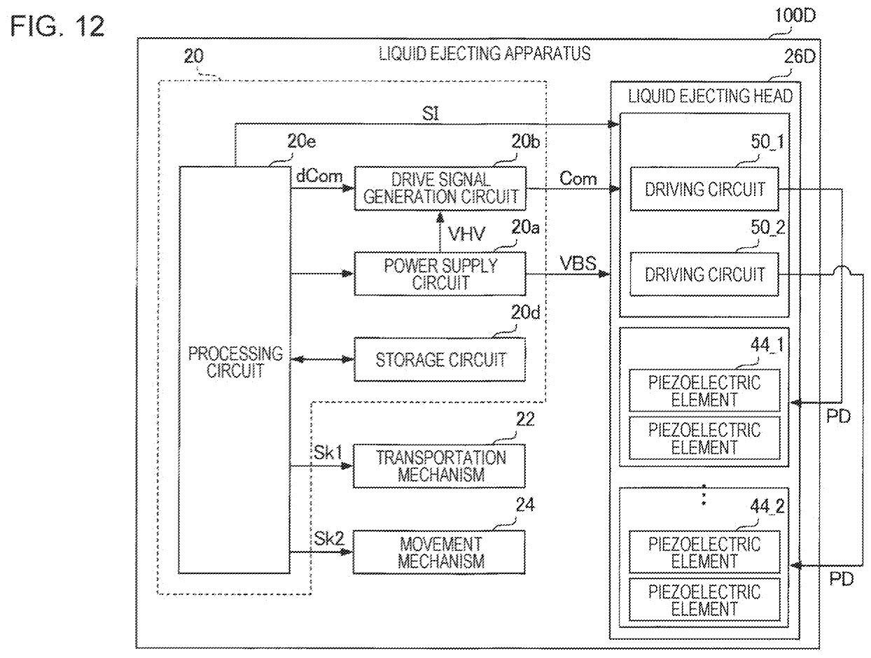

FIG. 12 is a block diagram illustrating a configuration example of a liquid ejecting apparatus 100D according to the fourth embodiment. The liquid ejecting apparatus 100D is the same as the liquid ejecting apparatus 100 according to the above-described first embodiment except that a liquid ejecting head 26D is provided instead of the liquid ejecting head 26. The liquid ejecting head 26D is the same as the liquid ejecting head 26 except that a first driving circuit 50_1 and a second driving circuit 50_2 are provided instead of the driving circuit 50.

The first driving circuit 50_1 is the same as the driving circuit 50 except that the first driving circuit 50_1 is electrically coupled to the first driving element 44_1 without being electrically coupled to the second driving element 44_2. The second driving circuit 50_2 is the same as the driving circuit 50 except that the second driving circuit 50_2 is electrically coupled to the second driving element 44_2 without being electrically coupled to the first driving element 44_1.

As described above, the liquid ejecting head 26D of this embodiment further includes the first driving circuit 50_1 and the second driving circuit 50_2. The first driving circuit 50_1 is electrically coupled to the first driving element 44_1. The second driving circuit 50_2 is provided separately from the first driving circuit 50_1 and is electrically coupled to the second driving element 44_2. By causing the first ejection element ELM_1 and the second ejection element ELM_2 to use the separate driving circuits as described above, it is possible to supply driving waveforms that are different from each other and suitable for the first ejection element ELM_1 and the second ejection element ELM_2, respectively, as compared to the configuration to use the driving circuit for the first ejection element ELM_1 and the second ejection element ELM_2 in common, thereby imparting substantially the same ejection performance to the first ejection element ELM_1 and the second ejection element ELM_2. Accordingly, it is possible to increase the number of the selectable nozzles, and thus to reduce power consumption for control when selecting and using one of these ejection elements.

### 5. Modified Examples

The respective embodiments described above may be modified in various ways. Specific aspects of modifications applicable to each of the above-described embodiments will be described below as examples. Note that two or more aspects to be arbitrarily selected from the following aspects may be combined as appropriate within the scope not contradicting each other.

### 5-1. First Modified Example

Each of the above-described embodiments exemplifies the configuration in which each of the first driving elements and the second driving elements is the piezoelectric element. However, the present disclosure is not limited only to this configuration, and each of the first driving elements and the second driving elements may be a heater. In other words, the type of the liquid ejecting head is not limited only to the piezoelectric type but may also be a thermal type.

### 5-2. Second Modified Example

Each of the above-described embodiments exemplifies the liquid ejecting apparatus 100 of a serial type configured to reciprocate the transportation body 242 that mounts the liquid ejecting head 26. However, the present disclosure is also applicable to a liquid ejecting apparatus of a line type configured to spread the nozzles N across the entire width of the medium 12.

### 5-3. Third Modified Example

The liquid ejecting apparatus 100 exemplified by each of the above-described embodiments is applicable not only to an apparatus dedicated to printing but also to various other apparatuses such as a facsimile apparatus and a copier. After all, the usage of the liquid ejecting apparatus of the present disclosure is not limited only to printing. For example, a liquid ejecting apparatus that ejects a liquid containing a coloring material is used as a manufacturing apparatus for forming a color filter of a liquid crystal display device. Meanwhile, a liquid ejecting apparatus that ejects a solution containing a conductive material is used as a manufacturing apparatus for forming wiring and electrodes on a wiring board. Moreover, a liquid ejecting apparatus of the present disclosure is also applicable to a three-dimensional printer, preparation of small amounts of chemical and medical agents, cell culture, vaccine manufacturing, and so forth.

What is claimed is:

1. A liquid ejecting head comprising:
a first ejection element that ejects a prescribed liquid; and
a second ejection element that ejects the prescribed liquid with a different ejection characteristic from an ejection characteristic of the first ejection element, wherein
the first ejection element includes
a first nozzle that ejects the liquid,
a first pressure chamber that communicates with the first nozzle,
a first driving element that applies a pressure to the liquid in the first pressure chamber, and
a first individual flow channel that communicates with the first pressure chamber,
the second ejection element includes
a second nozzle that ejects the liquid,
a second pressure chamber that communicates with the second nozzle,
a second driving element that applies a pressure to the liquid in the second pressure chamber, and
a second individual flow channel that communicates with the second pressure chamber, and
the ejection characteristic of the first ejection element and the ejection characteristic of the second ejection element when using the prescribed liquid are different from each other by satisfying at least one of conditions
that structures of the first nozzle and the second nozzle are different from each other,
that structures of the first pressure chamber and the second pressure chamber are different from each other,
that structures of the first driving element and the second driving element are different from each other, and
that structures of the first individual flow channel and the second individual flow channel are different from each other.

2. The liquid ejecting head according to claim 1, wherein a length of the second pressure chamber along a direction of circulation of the liquid is different from a length of the first pressure chamber along a direction of circulation of the liquid.

3. The liquid ejecting head according to claim 1, wherein a cross-sectional area of the second pressure chamber along a direction intersecting with a direction of circulation of the liquid is different from a cross-sectional area of the first pressure chamber along a direction intersecting with a direction of circulation of the liquid.

4. The liquid ejecting head according to claim 1, wherein an area of the second driving element is different from an area of the first driving element.

5. The liquid ejecting head according to claim 1, wherein a length of the second nozzle along a direction of circulation of the liquid is different from a length of the first nozzle along a direction of circulation of the liquid.

6. The liquid ejecting head according to claim 1, wherein a cross-sectional area of the second nozzle along a direction intersecting with a direction of circulation of the liquid is different from a cross-sectional area of the first nozzle along a direction intersecting with a direction of circulation of the liquid.

7. The liquid ejecting head according to claim 1, wherein a length of the second individual flow channel along a direction of circulation of the liquid is different from a length of the first individual flow channel along a direction of circulation of the liquid.

8. The liquid ejecting head according to claim 1, wherein a cross-sectional area of the second individual flow channel along a direction intersecting with a direction of circulation of the liquid is different from a cross-sectional area of the first individual flow channel along a direction intersecting with a direction of circulation of the liquid.

9. The liquid ejecting head according to claim 1, further comprising:
a third ejection element that ejects the prescribed liquid with a different ejection characteristic from the ejection characteristics of the first ejection element and of the second ejection element, wherein
the third ejection element includes
a third nozzle that ejects the liquid,
a third pressure chamber that communicates with the third nozzle,
a third driving element that applies a pressure to the liquid in the third pressure chamber, and
a third individual flow channel that communicates with the third pressure chamber, and
the ejection characteristic of the first ejection element, the ejection characteristic of the second ejection element, and an ejection characteristic of the third ejection element when using the prescribed liquid are different from one another by satisfying at least one of conditions
that a structure of the third nozzle is different from the structure of the first nozzle or the structure of the second nozzle,
that a structure of the third pressure chamber is different from the structure of the first pressure chamber or the structure of the second pressure chamber,
that a structure of the third driving element is different from the structure of the first driving element or the structure of the second driving element, and
that a structure of the third individual flow channel is different from the structure of the first individual flow channel or the structure of the second individual flow channel.

10. The liquid ejecting head according to claim 1, wherein
the first ejection element includes a plurality of nozzles arranged as the first nozzles, and
the second ejection element includes a plurality of nozzles arranged as the second nozzles along a direction of arrangement of the plurality of the nozzles of the first ejection element.

11. The liquid ejecting head according to claim 1, further comprising:
a first common flow channel that communicates with the first individual flow channel; and
a second common flow channel that communicates with the second individual flow channel without communicating with the first common flow channel.

12. The liquid ejecting head according to claim 1, further comprising:
a first driving circuit electrically coupled to the first driving element; and
a second driving element provided separately from the first driving circuit and electrically coupled to the second driving element.

13. A method of using the liquid ejecting head according to claim 1, comprising:
obtaining, as a first step, first information concerning an ejection characteristic when driving the first driving element in a state of filling the first pressure chamber with the prescribed liquid;
obtaining, as a second step, second information concerning an ejection characteristic when driving the second driving element in a state of filling the second pressure chamber with the prescribed liquid; and
selecting, as a third step, one of a plurality of ejection elements including the first ejection element and the second ejection element based on the first information and the second information.

14. The method of using the liquid ejecting head according to claim 13, further comprising:
performing, as a fourth step, printing with the liquid ejected from the liquid ejecting head without using the ejection element not selected in the third step but instead by using the ejection element selected in the third step.

15. The method of using the liquid ejecting head according to claim 13, further comprising:
transmitting, as a fifth step, information concerning a result of the third step to an external device.

16. The method of using the liquid ejecting head according to claim 13, wherein
information concerning a state of the liquid ejected from the first nozzle by driving the first driving element is obtained as the first information in the first step, and
information concerning a state of the liquid ejected from the second nozzle by driving the second driving element is obtained as the second information in the second step.

17. The method of using the liquid ejecting head according to claim 13, wherein
information concerning residual vibration occurring in the first pressure chamber by driving the first driving element is obtained as the first information in the first step, and
information concerning residual vibration occurring in the second pressure chamber by driving the second driving element is obtained as the second information in the second step.

18. The method of using the liquid ejecting head according to claim 13, wherein
information concerning an evaluation of the ejection characteristic of the first ejection element is obtained in the first step as the first information based on a physical property of the prescribed liquid and on a predetermined lookup table, and
information concerning an evaluation of the ejection characteristic of the second ejection element is obtained in the second step as the second information based on the physical property of the prescribed liquid and on the predetermined lookup table.

19. The method of using the liquid ejecting head according to claim 13, wherein
information concerning an evaluation of the ejection characteristic of the first ejection element is obtained in the first step as the first information by using a simulation, and
information concerning an evaluation of the ejection characteristic of the second ejection element is obtained in the second step as the second information by using a simulation.

20. A liquid ejecting apparatus comprising:
the liquid ejecting head according to claim 1; and
a control unit that controls an operation to eject the liquid from the liquid ejecting head.
